(19) United States
(12) Patent Application Publication
(10) Pub. No.: US 2004/0078437 A1
(43) Pub. Date: Apr. 22, 2004

(54) System for providing automated storage of e-mail messages

(76) Inventor: Gustavo M. Guillemin, Guadalajara (MX)

Correspondence Address: HEWLETT-PACKARD COMPANY, Intellectual Property Administration, P.O. Box 272400, Fort Collins, CO, 80527-2400, US

(21) Appl. No.: 10/274,023

(22) Filed: Oct. 17, 2002

(51) Int. Cl. G06F 15/16

(52) U.S. Cl. 709/206

(57) ABSTRACT

Generating an e-mail message that includes data indicating that the e-mail message is to be stored on a computer system of the receiver. Software receiving the e-mail message reads the data indicating that the e-mail message is to be stored and stores contents of the e-mail message in a specified location for future retrieval by the receiver. A method embodying the present invention includes receiving a request from a sender to store an e-mail message on a processing system of a receiver. A flag indicating the e-mail message is to be stored in a location other than the receiver's in box, is set in the e-mail message. The e-mail message is then transmitted to a selected receiver. Software receiving the e-mail message for the receiver reads the flag indicating the contents of the e-mail message is to be stored. The software then stores the contents of the e-mail message in a location other than the receiver's in box. In various embodiments, the sender or the receiver of the e-mail message specifies a path name identifying a logical memory area to which the contents of the e-mail are to be stored.

### FIELD

The present invention relates to a software product that is executable by a processing system to allow a sender or a receiver to have an e-mail message stored automatically in a memory connected to a processing system.

### BACKGROUND

In today's society, e-mail is a common mode of communication. E-mail messages are electronic messages that include text, data files, and executable files that are transmitted between users via networks such as a LAN or the Internet. In fact, e-mail has become a common method for large entities, such as businesses and classes, to disseminate information to large groups of people, such as employees and students since any number of copies of the e-mail messages may be transmitted.

Sometimes, the sender of an e-mail message desires that the recipient of the message store the e-mail for future reference. Alternatively, the sender may want to store a copy of the message for future reference. For example, an employer may transmit an e-mail message to employees that contains updated or new guidelines for operating the business. The employer has no way of knowing whether the employees has received and stored the guidelines. Further, the employer may wish to store a copy of the message on the employer's computer as proof that the guidelines were sent to all employees.

A second example is between a contractor and a particular customer. The contractor may wish to keep a copy of all messages sent between the contractor and a particular customer in a particular folder on the contractor's computer system. This allows the contractor to keep a record of the evolution of a particular project.

In conventional e-mail systems, most or all received mail is stored in an in box—a logical memory area that functions not unlike a mail box for traditional paper mail. Similarly, a copy of sent mail is placed in a sent box. To conserve memory and reduce “clutter,” the in box and the sent box are periodically emptied. Often this results in important messages being inadvertently deleted.

Therefore, there is a need for a system that provides a sender of an e-mail message containing important information or data with some reasonable degree of assurance that a recipient will have the information for future reference. The system should also allow a recipient to selectively or automatically store in a selected location all e-mail messages from a particular sender. Furthermore, the system should also allow a sender to store e-mail messages for future reference.

### SUMMARY

Accordingly, the present invention will allow a sender to generate an e-mail message that includes data indicating that the e-mail message is to be stored on a computer system of the recipient. Software receiving the e-mail message reads the data indicating that the e-mail message is to be stored and stores contents of the e-mail message in a specified location for future retrieval by the recipient. A method embodying the present invention includes receiving a request from a sender to store an e-mail message on a processing system of a recipient. A flag indicating the e-mail message is to be stored in a location other than the receiver's in box, is set in the e-mail message. The e-mail message is then transmitted to a selected recipient. Software receiving the e-mail message for the recipient reads the flag indicating the contents of the e-mail message is to be stored. The software then stores the contents of the e-mail message in a location other than the receiver's in box. In various embodiments, the sender or the receiver of the e-mail message specifies a path name identifying a logical memory area to which the contents of the e-mail are to be stored.

### DESCRIPTIONS OF THE DRAWINGS

FIG. 1 illustrates a personal computer connected to a server through telephone lines.

FIG. 2 illustrates a group of computers connected by a LAN (Local Area Network);

FIG. 3 is a block diagram of a processing system that may execute the system of this invention;

FIG. 4 is a flow diagram illustrating steps taken to generate an e-mail message to be stored automatically for a recipient according to an embodiment of the present invention;

FIG. 5 is a block diagram illustrating steps taken, for a recipient, to automatically store a received e-mail according to an embodiment of the present invention;

FIG. 6 is a flow diagram illustrating steps taken to generate an e-mail message to be stored for a recipient according to a preferred embodiment of the present invention; and

FIG. 7 is a flow diagram illustrating steps taken, for a recipient, to automatically store a received e-mail according to an embodiment of the present invention according to a preferred embodiment of the present invention.

FIG. 8 is a logical illustration of an e-mail message.

### DETAILED DESCRIPTION

INTRODUCTION: It is expected that various embodiments of the present invention will help to assure a sender of an e-mail message that a recipient has a stored copy of the contents of that e-mail message. The following description and the drawings illustrate only a few exemplary embodiments of the invention. Other embodiments, forms, and details may be made without departing from the scope of the invention, which is expressed in the claims that follow this description.

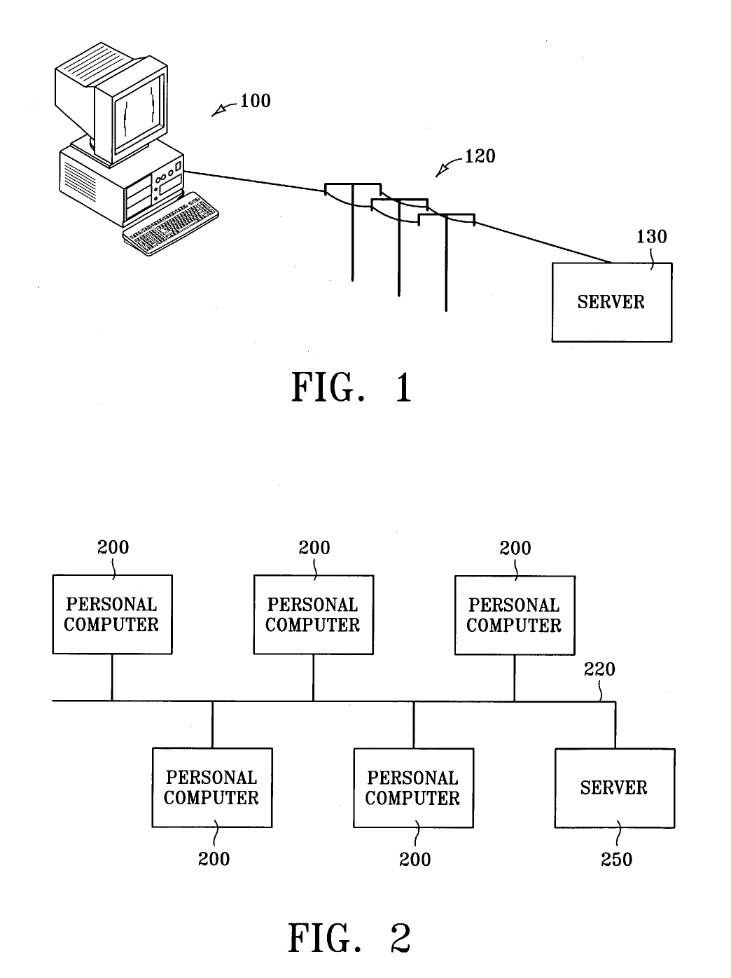

ENVIRONMENT: FIGS. 1 and 2 illustrate various networking environments in which the present invention may be incorporated. FIG. 1 illustrates a typical personal computer 100 connected via telephone network 120 to a server 130. Personal computer 100 is an example of a typical processing system that can execute software instructions for this invention. FIG. 2 illustrates personal computers 200 connected via LAN (Local Area Network) 220 to server 250.

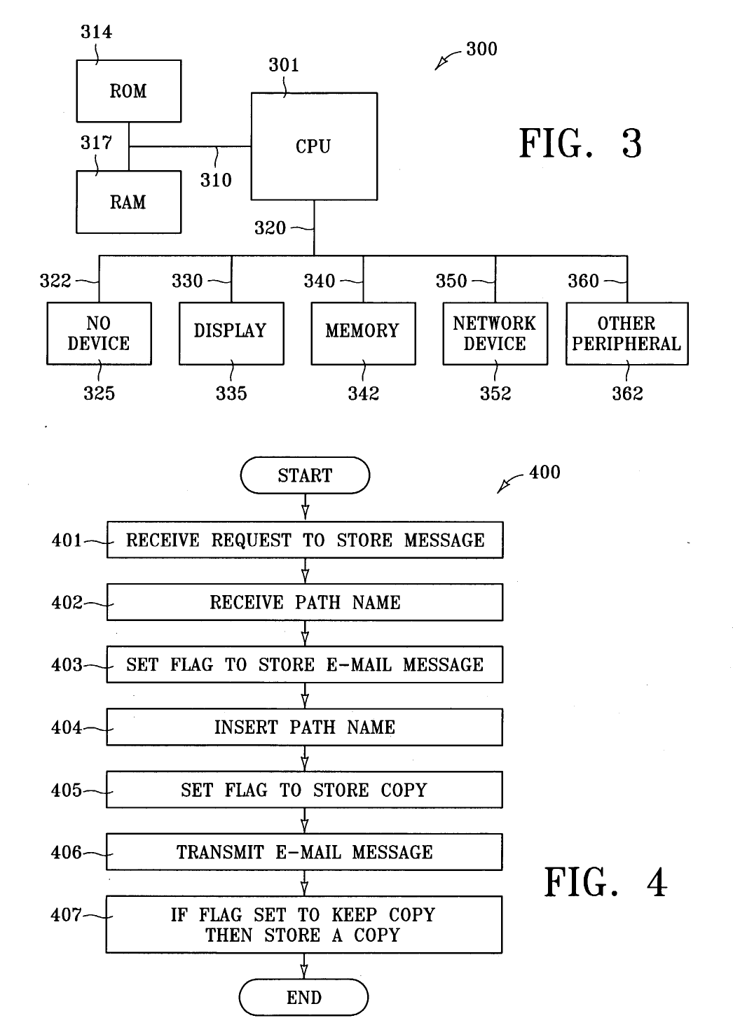

FIG. 3 illustrates a block diagram of typical processing system 300 such as personal computers 100 and/or 200. Processing system 300 has a CPU (Central Processing Unit) 301. CPU 301 is a processor, microprocessor, or a group of multiple processors or microprocessors that execute instructions stored in a memory to perform applications. Memory bus 310 connects CPU 301 with a non-volatile memory, such as ROM (Read Only Memory) 314, and a volatile memory, such as RAM (Random Access Memory) 317. ROM 314 is non-volatile memory used to store configuration information and instructions for set-up of processing system 300. RAM 317 is a volatile memory used to store data and instructions of applications being executed by CPU 301.

I/O (Input/Output) bus 320 connects CPU 301 to peripheral devices. Path 322 connects I/O device 325 to I/O bus 320. I/O device 325 is a keyboard and/or mouse that allows a user to input data into processing system 300. Path 330 connects display 335 to I/O bus 320. Display 335 is a monitor that allow processing system 300 to present information to users. Path 340 connects memory 342 to I/O bus 320. Memory 342 is a secondary memory such as a hard drive or a device such as a disk drive that reads and writes data to a media.

Path 350 connects network device 352 to I/O bus 320. Network device 352 is a modem or Ethernet card that connects processing system 300 to a network to allow for communication with other processing systems. Path 360 connects other peripheral devices 362 to I/O bus 320.

OPERATION: A user of processing system 300 sends e-mail messages in the following manner. First, the user activates e-mail software. The user selects an icon or enters a command requesting the software to present an interface enabling the user to generate or assemble a new e-mail message. With the provided interface, the user inserts text, data files, and/or executable files into the message. The message is then directed to an e-mail address of a receiver. An e-mail address is typically an Internet address of the recipient's server. After the e-mail message is completed, the sender requests that the e-mail software transmit the message via a network to the sender's e-mail server. The sender's e-mail server transmits the message to the recipient's e-mail address.

FIG. 4 is a flow diagram illustrating a process for generating an e-mail message that is to be stored for the recipient. Process 400 begins in step 401 by receiving a request to automatically store an e-mail message for a recipient. In step 402, process 400 may perform the optional step of receiving a path name identifying a logical memory area in which to store the e-mail.

A flag is set in the e-mail message in step 403 to indicate that the message is to be stored in a location other than the receiver's in box. The flag is read by the software of the system receiving the e-mail. The flag may be a simple bit that is activated to indicate the e-mail message is to be stored. As an example, the flag may be in a header of an e-mail message. A header is a region typically found at the beginning of an e-mail message where book keeping information is kept. Book keeping information, however, can be located anywhere in the e-mail message. Book keeping information includes data such as the date and time the message was sent, the source of the message, and other similar information.

If a path name is received in step 402, the path name is inserted into the e-mail message. Again the path name can be inserted into the header or any other location of the e-mail message containing book keeping information. Where a path name is not received, the e-mail message may be stored to a default path name or the recipient may specify a path name. In step 405, process 400 receives a request to store a copy of the message on the processing system of the sender. In step 406, the e-mail message is transmitted to the address of the recipient.

In step 407, if a flag was set in step 405, the e-mail message is stored to a memory associated with the processing system of the sender. It is expected that programming operating on the sender's processing system will prompt the sender for a path name identifying a logical memory area to which the copy is to be stored. Alternatively that same programming may provide a default path name.

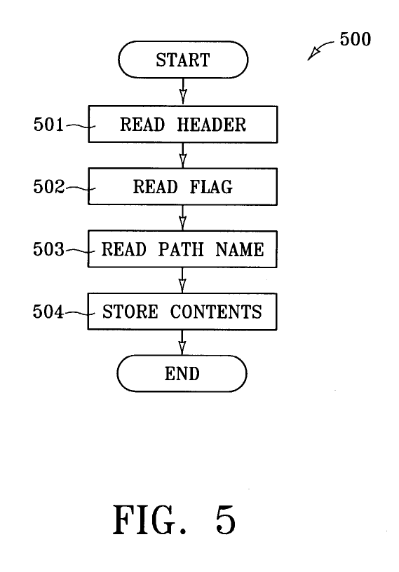

FIG. 5 is a flow diagram illustrating a process 500 executed by a processing system receiving an e-mail that is to be automatically stored. Process 500 begins in step 501 scanning the received e-mail message for bookkeeping information. In step 502, a flag is read indicating the message is to be stored in a location other than the receiver's in box. A path name, if one exists in the e-mail message, is read in step 503. In step 504, the contents of the message are stored in a logical memory area specified by the path name read in step 503. Alternatively, the contents of the message are stored in a logical memory area specified by a default path name if a path name is not included in the e-mail message.

It is important to recognize that storing an e-mail message may involve storing the entire e-mail message or a selected portion or portions. For example, an e-mail message may include an attachment—a employee handbook for example. Storing may then involve storing only the attachment in a specified location, preferably in a location containing other employment related materials.

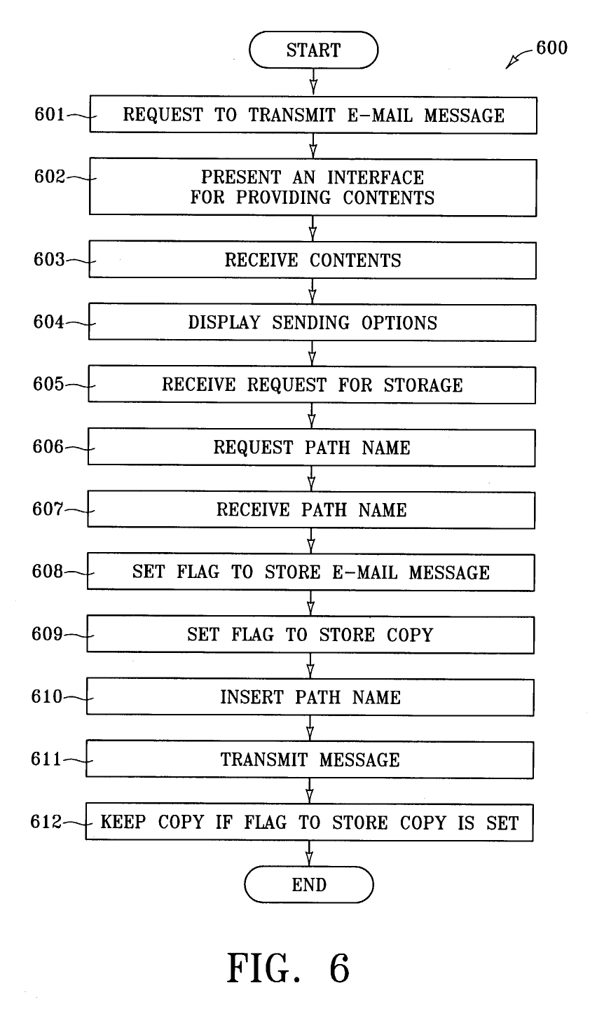

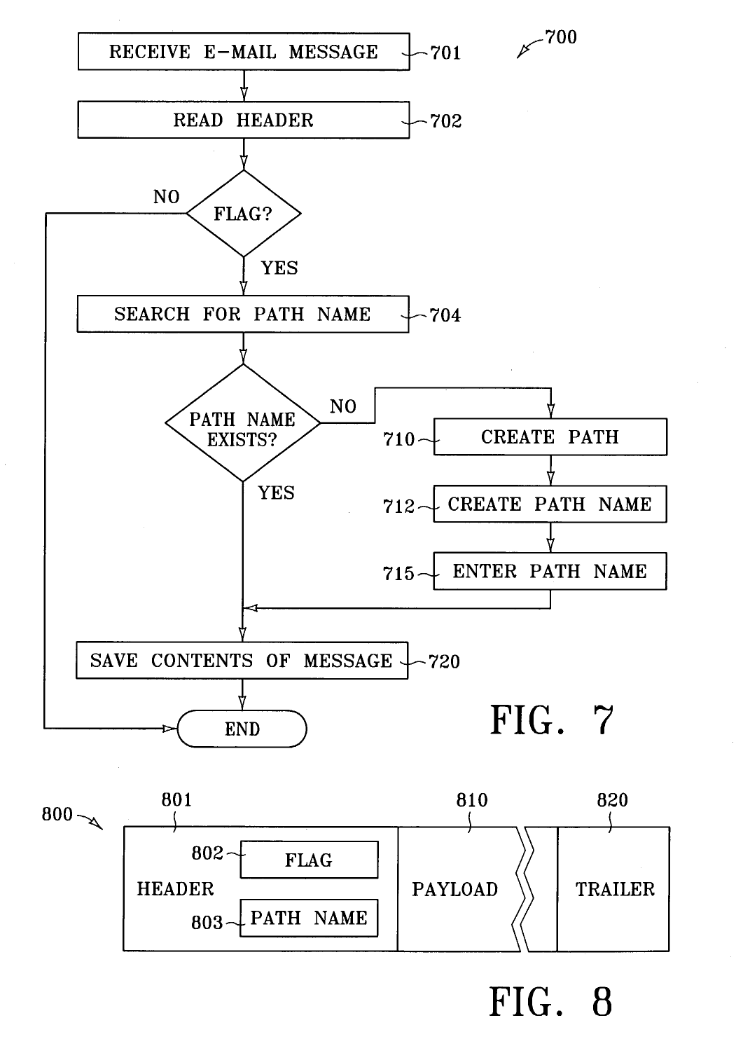

FIGS. 6 and 7 are flow diagrams illustrating preferred processes for automatically storing e-mail messages. FIG. 6 illustrates process 600 which a preferred embodiment of the software for generating an e-mail message to be automatically stored. Process 600 begins in step 601 in which a request to transmit an e-mail is received. In step 602, the processing system presents an interface enabling a user to provide or identify contents including attachments of the e-mail message. Those contents are received in step 603. In step 604, the processing system also provides an interface enabling the sender to select options for sending the e-mail message in step 604. The options include automatic e-mail storing.

In step 605, a request to automatically store the e-mail message is received. This, for example, may be from the sender clicking a mouse on a check box displayed in the interface provided in step 604. In step 606, a path name for storing the e-mail message is requested. In doing so the processing system may provide an interface enabling the sender to enter the path name. The sender enters a path name, and process 600 receives that path name in step 607.

A flag is set in the header of the e-mail message in step 608 to indicate the message is to be stored in a location other than the receiver's in box. In step 609 another flag may be set in the e-mail message indicating that a copy of the e-mail message is to be stored on the sender's processing system. In step 610, the path name is also inserted into the header of the e-mail message. The path name may be received from the sender. The path name may also be a default path name inserted by programming running on the sender's processing system. Process 600 then transmits the e-mail message in step 611, and ends following step 612 with a copy of the e-mail message being stored on the sender's processing system.

FIG. 7 illustrates is a flow diagram illustrating a process 700 for receiving an e-mail generated and transmitted according to process 600. Process 700 begins in step 701 with the receiver's processing system receiving an e-mail message. In step 702, process 700 reads the header and reads a flag to determine if the e-mail message is to be stored in a location other than the receiver's in box. Where, as in this case, the flag does indicate the e-mail message is to be stored, the header is searched for a path name in step 704. It is important to keep in mind that book keeping information such as the flag and path name need not be located in the header. Such data can be placed anywhere in the e-mail message. It is also possible at this point to request a path name to store the message from the recipient or have programming operating on the receiver's processing system set a default path name.

If the path name exists, process 700 ends in step 720 by storing the contents of the e-mail message in a logical memory area identified by the path name. As stated above, the e-mail message in its entirety or any portion thereof may be stored.

If the path name does not exist, process 700 prompts the receiver to determine whether the receiver wants to create the path name in step 710. If an indication is received from the recipient that indicates that path name is to be created in step 710. The path name is then created in step 712. The contents of the e-mail message, in step 720, are stored to the path name selected by the receiver and process 700 ends. Alternatively, where a problem exists with the path name selected by the receiver, the receiver is prompted for a new path name in step 715. Process 700 is then repeated from step 710 and an existing path name is given.

FIG. 8 is a block diagram logically illustrating the contents of an e-mail message 800. E-mail message 800 includes a header 801. Header 801 includes delivery information including the address of the recipient. Flag 802 is a bit in header 801. The bit is set or not set to indicate if the message is to be stored. Path name 803 may be inserted into header 801 if the sender or sender software indicates the path name where the e-mail message is to be stored. The path name may be input by the sender or the sender software may insert a default path name. In cases where a path name is not included, the receiver software determines the path name where the e-mail message is stored.

Payload 810 stores the contents of the e-mail message. Payload 810 includes the text, data files, and/or executable files. Payload 810 may also include a secondary header for the software generating and receiving the e-mail messages. Payload 810 is of a varying length. Trailer 820 is appended to the end of payload 810. Trailer 820 contains information needed for delivery and handling of the e-mail message.

The present invention has been shown and described with reference to the foregoing exemplary embodiments. It is to be understood, however, that other forms, details, and embodiments may be made without departing from the scope of the invention, which is defined in the following claims.

What is claimed is:

1. Computer readable media having instructions for:
receiving a request from a sender to store an e-mail message on a processing system of a receiver in a location other than the receiver's in box;
setting a flag in the e-mail message indicating that the e-mail message is to be stored in a location other than the receiver's in box; and
transmitting the e-mail message to the receiver.

2. The media of claim 1, having further instructions for receiving a path name identifying a logical memory area to which the e-mail message is, to be stored, and inserting the path name into the e-mail message.

3. The media of claim 1, further comprising instructions for receiving a request to transmit the e-mail message.

4. The media of claim 3, having further instructions for requesting contents of the e-mail message from the sender in response to receiving a request to transmit the e-mail message, and receiving the contents from the sender.

5. The media of claim 3, having further instructions for receiving a request to store the e-mail message for the sender, requesting a path name from the sender, receiving the path name from the sender, and inserting the path name into the e-mail message.

6. The media of claim 1, having further instructions for receiving an e-mail message, reading a flag from the e-mail message indicating that the e-mail message is to be stored in a location other than the receiver's in box, and storing contents of the e-mail message in a location other than the receiver's in box.

7. The media of claim 6, having further instructions for reading a path name from the e-mail message, and wherein the instructions for storing contents comprise storing contents in a logical memory area identified by the path name.

8. The media of claim 7, having further instructions for determining whether a path name exists, and wherein the instructions for storing contents comprise further instructions for storing contents in response to a determination of whether a path name exists.

9. The media of claim 8, having further instructions for requesting a path name identifying a logical memory area to which the e-mail message is to be stored in response to a determination that a path name does not exist, and wherein the instructions for storing comprise instructions for storing the contents according to the path name.

10. The media of claim 8, having further instructions for, in response to a determination that a path name does exist, displaying a query of whether to create a path name, and generating a path name in response to an affirmative indication.

11. Computer readable media having instructions for:
receiving an e-mail message;
reading a flag from the e-mail message indicating that the e-mail message is to be stored in a location other than a receiver's in box; and
storing contents of the e-mail message in a location other than the receiver's in box.

12. The media of claim 11, having further instructions for reading a path name from the e-mail message, and wherein the instructions for storing contents comprise storing contents in a logical memory area identified by the path name.

13. The media of claim 12, having further instructions for determining whether a path name exists, and wherein the instructions for storing contents comprise further instructions for storing contents in response to a determination of whether a path name exists.

14. The media of claim 13, having further instructions for requesting a path name identifying a logical memory area to which the e-mail message is to be stored in response to a determination that a path name does not exist, and wherein the instructions for storing comprise instructions for storing the contents according to the path name.

15. The media of claim 13, having further instructions for, in response to a determination that a path name does exist, displaying a query of whether to create a path name, and generating a path name in response to an affirmative indication.

16. A method for providing automatic e-mail storage, comprising: receiving a request from a sender to store an e-mail message on a processing system of a receiver in a location other than the receiver's in box;
setting a flag in the e-mail message indicating that the e-mail message is to be stored in a location other than the receiver's in box; and
transmitting the e-mail message to the receiver.

17. The method of claim 16, further comprising receiving a path name identifying a logical memory area to which the e-mail message is to be stored and inserting the path name into the e-mail message.

18. The method of claim 16, further comprising receiving a request to transmit the e-mail message.

19. The method of claim 18, further comprising requesting contents of the e-mail message from the sender in response to receiving a request to transmit the e-mail message and receiving the contents from the sender.

20. The method of claim 18, further comprising receiving a request to store the e-mail message for the sender, requesting a path name from the sender, receiving the path name from the sender, and inserting the path name into the e-mail message.

21. The method of claim 16, further comprising receiving the e-mail message, reading a flag from the e-mail message indicating that the e-mail message is to be stored in a location other than the receiver's in box, and storing contents of the e-mail message in a location other than the receiver's in box.

22. The method of claim 21, further comprising reading a path name from the e-mail message, and wherein storing contents comprises storing the contents in a logical memory area identified by the path name.

23. The method of claim 22, further comprising determining whether a path name exists, and wherein storing contents comprises storing the contents in response to a determination of whether a path name exists.

24. The method of claim 23, further comprising requesting a path name identifying a logical memory area to which the e-mail message is to be stored in response to a determination that a path name does not exist and wherein storing contents comprises storing the contents according to the path name.

25. The method of claim 23, further comprising, in response to a determination that a path name does exist, displaying a query of whether to create a path name and generating a path name in response to an affirmative indication.

26. A method for automatic e-mail storage, comprising:
receiving an e-mail message;
reading a flag from the e-mail message indicating that the e-mail message is to be stored in a location other than a receiver's in box; and
storing contents of the e-mail message in a location other than the receiver's in box.

27. The method of claim 26, further comprising reading a path name from the e-mail message, and wherein the instructions for storing contents comprise storing contents in a logical memory area identified by the path name.

28. The method of claim 27, further comprising determining whether a path name exists, and wherein storing contents comprises storing the contents in response to a determination of whether a path name exists.

29. The method of claim 28, further comprising requesting a path name identifying a logical memory area to which the e-mail message is to be stored in response to a determination that a path name does not exist, and wherein storing contents comprises storing the contents according to the path name.

30. The method of claim 28, further comprising, in response to a determination that a path name does exist, displaying a query of whether to create a path name, and generating a path name in response to an affirmative indication.
